(19) United States
(12) Patent Application Publication
(10) Pub. No.: US 2010/0109525 A1
(43) Pub. Date: May 6, 2010

(54) PLASMA DISPLAY PANEL

(76) Inventors: Shinichiro Nagano, Suwon-si (KR); Sang-Hun Jang, Suwon-si (KR); Yong-Mi Yu, Suwon-si (KR)

Correspondence Address: CHRISTIE, PARKER & HALE, LLP, PO BOX 7068, PASADENA, CA, 91109-7068, US

(21) Appl. No.: 12/610,035

(22) Filed: Oct. 30, 2009

(30) Foreign Application Priority Data
Nov. 4, 2008 (KR) 10-2008-0108989

(51) Int. Cl. H01J 17/49

(52) U.S. Cl. 313/582

(57) ABSTRACT

A plasma display panel for improving luminous efficiency including first and second substrates facing each other; barrier ribs partitioning a space between the first and second substrates to define discharge cells; address electrodes on the first substrate and extending along a first direction to correspond to the discharge cells; first and second electrodes extending along a second direction crossing the first direction on the second substrate to define a discharge gap at centers of the discharge cells; a dielectric layer covering the first and second electrodes; and a protective layer covering the dielectric layer. The dielectric layer includes a first section in the discharge gap and a portion adjacent to the discharge gap in the first direction and having a smaller dielectric constant, and a second section at either side of the first dielectric constant section in the first direction and having a larger dielectric constant.

### CROSS-REFERENCE TO RELATED APPLICATION

This application claims priority to and the benefit of Korean Patent Application No. 10-2008-0108989, filed in the Korean Intellectual Property Office on Nov. 4, 2008, the entire content of which is incorporated herein by reference.

### BACKGROUND OF THE INVENTION

1. Field of the Invention

The present invention relates to a plasma display panel. More particularly, the present invention relates to a plasma display panel that can improve luminous efficiency.

2. Description of the Related Art

In general, an AC-type plasma display panel (PDP) includes a display electrode that forms a discharge gap to perform surface discharge, a dielectric layer that covers the display electrode and an inner surface of a front substrate, and a protective layer that covers the dielectric layer.

In gas discharge, a stronger electric field is concentrated on the discharge gap and a portion adjacent to the discharge gap than the outline of the discharge cell. Therefore, in order to protect the dielectric layer from sputtering that occurs due to the strong electric field, an exemplary protective layer has a relatively low secondary electron emission coefficient at the portion adjacent to the discharge gap. In this case, discharge firing voltage rises due to this low secondary electron emission coefficient.

In another example, the dielectric layer has a high dielectric constant at the portion adjacent to the discharge gap and a low dielectric constant at a portion away from the discharge gap. In this case, crosstalk, that is, wrong discharge is suppressed by the high dielectric constant, and the gas discharge is stabilized in the vicinity of the discharge gap.

However, the high dielectric constant causes the strong electric field, that is, high-density plasma to be formed at the portion adjacent to the discharge gap, thereby increasing energy loss and lowering luminous efficiency.

The above information disclosed in this Background section is only for enhancement of understanding of the background of the invention and therefore it may contain information that does not form the prior art that is already known in this country to a person having ordinary skill in the art.

### SUMMARY OF THE INVENTION

An aspect of an embodiment of the present invention is directed toward a plasma display panel having an improved luminous efficiency.

An exemplary embodiment of the present invention provides a plasma display panel that includes a first substrate; a second substrate facing the first substrate; a plurality of barrier ribs partitioning a space between the first substrate and the second substrate to define a plurality of discharge cells; a plurality of address electrodes on the first substrate and extending in a first direction to correspond to the discharge cells; a first electrode and a second electrode extending in a second direction crossing the first direction on the second substrate to define a discharge gap at the center of a corresponding one of the discharge cells; a dielectric layer covering the first and second electrodes; and a protective layer covering the dielectric layer, wherein the dielectric layer includes a first dielectric constant section in the discharge gap and a portion adjacent to the discharge gap in the first direction and having a first dielectric constant, and a second dielectric constant section at either side of the first dielectric constant section in the first direction and having a second dielectric constant larger than the first dielectric constant.

The first dielectric constant section may include insulator particles that are not sintered. The insulator particles may have a property for not absorbing visible light. The insulator particles may include SiO₂ and/or Al₂O₃.

The second dielectric constant section may be sintered. The second dielectric constant section may be formed on a surface of each of the first and second electrodes facing the first substrate, and on a surface of the second substrate facing the first substrate and not covered with the first and second electrodes.

The first dielectric constant section may be formed on a surface of the second dielectric constant section facing the first substrate.

The first dielectric constant section may be sintered. Further, the second dielectric constant section may be sintered. The second dielectric constant section may be formed by a dispenser method (i.e., may be a dispensed dielectric constant section).

The first dielectric constant section may cover a surface of the second substrate facing the first substrate to correspond to the discharge gap, and may convert a surface of each of the first and second electrodes facing the first substrate at a portion adjacent to the discharge gap in the first direction.

The second dielectric constant section may cover a surface of each of the first and second electrodes facing the first substrate, and may cover a surface of the second substrate facing the first substrate at either side of the first dielectric constant section in the first direction.

### BRIEF DESCRIPTION OF THE DRAWINGS

FIG. 1 is an exploded perspective schematic view of a plasma display panel according to a first exemplary embodiment of the present invention.

FIG. 2 is a cross-sectional schematic view taken along line II-II of FIG. 1.

FIG. 3 is a plan schematic view of a disposition relationship of a display electrode, a first dielectric constant section, and a discharge cell.

FIG. 4 is a graph illustrating a relationship between luminance and luminous efficiency depending on sustain discharge voltage and a width of a first dielectric constant section.

FIG. 5 is a cross-sectional schematic view of a plasma display panel according to a second exemplary embodiment of the present invention.

### DESCRIPTION OF REFERENCE NUMERALS INDICATING CERTAIN ELEMENTS IN THE DRAWINGS

100: Plasma display panel 10: First substrate (Rear substrate)

20: Second substrate (Front substrate) 11: Address electrode

13, 21: First and second dielectric layer 16: Barrier rib

16a, 16b: First and second barrier rib member

17: Discharge cell 19: Phosphor layer

21a, 121a: First dielectric constant section

21b, 121b: Second dielectric constant section 23: Protective layer

31: Sustain electrode 32: Scan electrode

31a, 32a: Transparent electrode 31b, 32b: Bus electrode

DG: Discharge gap F1, F2: First and second regions

T1, T2: Thickness of first and second dielectric constant section

W1: Width

ε1, ε2: Dielectric constants of first and second dielectric constant section

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention. The drawings and description are to be regarded as illustrative in nature and not restrictive. Like reference numerals designate like elements throughout the specification.

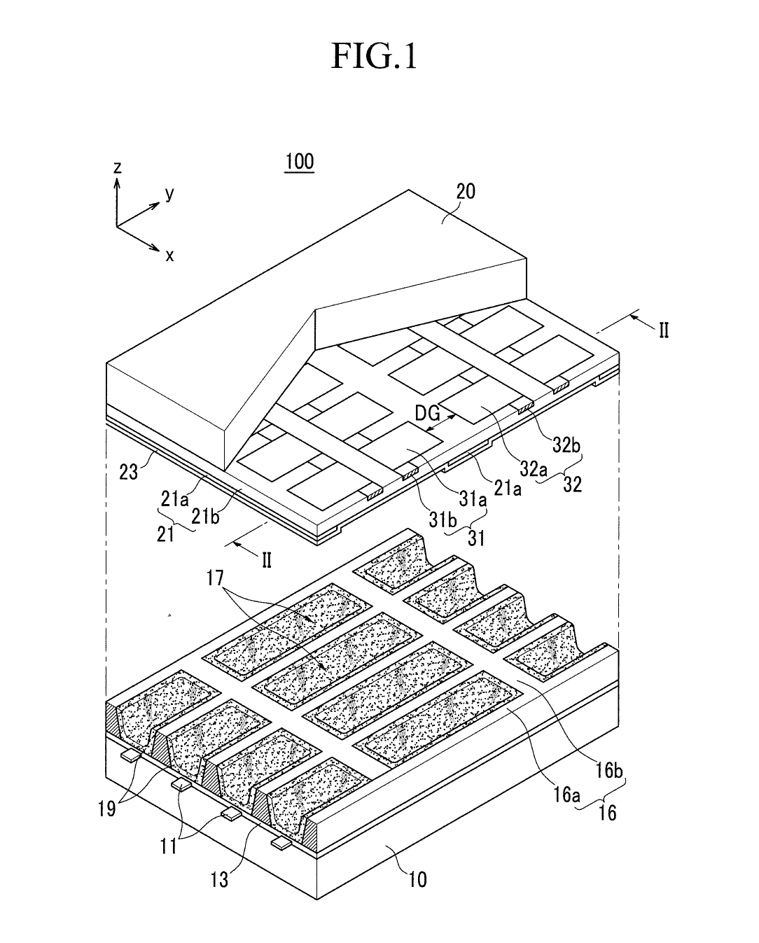

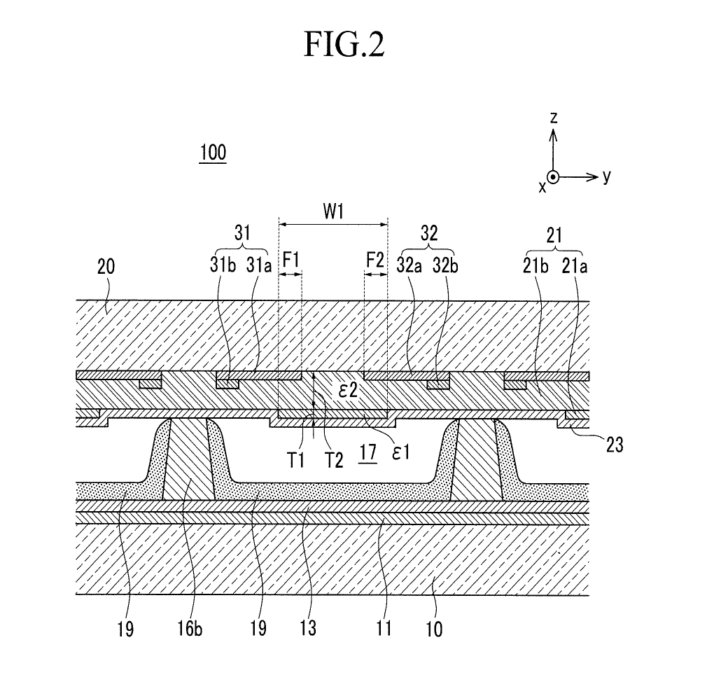

FIG. 1 is an exploded perspective schematic view of a plasma display panel according to a first exemplary embodiment of the present invention. FIG. 2 is a cross-sectional schematic view taken along line H-H of FIG. 1.

Referring to FIGS. 1 and 2, the plasma display panel 100 according to the first exemplary embodiment includes a first substrate (hereinafter, “rear substrate”) 10 and a second substrate (hereinafter, “front substrate”) 20 that are attached to face each other with a space therebetween, and a barrier rib 16 disposed between the rear and front substrates 10 and 20.

The barrier rib 16 partitions a space provided between the rear substrate 10 and the front substrate 20 to form a plurality of discharge cells 17. Phosphor layers 19 are formed in the discharge cells 17 and are filled with discharge gas (i.e., mixed gas containing neon (Ne), xenon (Xe), etc.).

The discharge gas generates vacuum ultraviolet rays by gas discharge. While the phosphor layers 19 are excited by the vacuum ultraviolet rays, and then stabilized to emit visible light of red (R), green (G), and blue (B). To cause the gas discharge, address electrodes 11 and display electrodes are disposed in the discharge cells 17.

In one example, the address electrodes 11 extend along an inner surface of the rear substrate 10 facing the front substrate 20 in a first direction (hereinafter, referred to as “y-axis direction”) and correspond to the discharge cells 17 adjacent in the y-axis direction. The plural address electrodes 11 are disposed parallel to the discharge cells 17 adjacent in a second direction (hereinafter, referred to as “x-axis direction”) crossing the y-axis direction.

A first dielectric layer 13 covers the inner surface of the rear substrate 10 and the address electrodes 11. The first dielectric layer 13 protects the address electrodes 11 from the gas discharge by blocking (or preventing) positive ions or electrons from colliding directly with the address electrodes 11 in discharge. Further, the first dielectric layer 13 provides forming and accumulation spaces of wall charges to enable address discharge by low voltage.

The address electrodes 11 are disposed on the rear substrate 10 so as not to interrupt penetration of the visible light through the front substrate 20. Therefore, the address electrodes 11 may be formed of an opaque electrode, that is, a metal electrode such as silver (Ag) having high electrical conductivity.

The barrier rib 16 is disposed on the first dielectric layer 13 and partitions a space between the first dielectric layer 13 and the front substrate 20. For example, the barrier rib 16 includes first barrier rib members 16a that extend along the y-axis direction, and second barrier rib members 16b that connect the adjacent first barrier rib members 16a to each other in the x-axis direction and are disposed to be spaced apart from each other in the y-axis direction.

That is, the first barrier rib members 16a partition the discharge cells 17 adjacent in the x-axis direction, and the second barrier rib members 16b partition the discharge cells 17 adjacent in the y-axis direction. Therefore, in a quadrangular barrier rib structure, the discharge cells 17 are arranged in a matrix.

The phosphor layers 19 may be formed by applying a phosphor paste onto side surfaces of the first barrier rib 16a and the second barrier rib 16b and the surface of the first dielectric layer 13 defined (or surrounded) by the first barrier rib 16a and the second barrier rib 16b, and drying and sintering the applied phosphor paste.

The phosphor layers 19 are formed of phosphors that generate visible light of the same color in the discharge cells 17 in the y-axis direction. The phosphor layers 19 are formed of phosphors that generate visible light of red (R), green (G), and blue (B) in the discharge cells 17 in the x-axis direction. That is, the phosphor layers 19 that are formed of the phosphors generating the visible light of red (R), the phosphors generating the visible light of green (G), and the phosphors generating the visible light of blue (B) are repetitively and respectively disposed in the x-axis direction.

The display electrodes include a first electrode (hereinafter, referred to as “sustain electrode”) 31 and a second electrode (hereinafter, referred to as “scan electrode”) 32 formed on the inner surface of the front substrate 20 facing the rear substrate 10, which correspond to the discharge cells 17. The sustain electrode 31 and the scan electrode 32 form a surface discharge structure in correspondence with each of the discharge cells 17.

The sustain electrode 31 and the scan electrode 32 are paired in the x-axis direction crossing the address electrode 11. A discharge gap DG is formed between the sustain electrode 31 and the scan electrode 32. The discharge gap DG corresponds to the center of the discharge cell 17.

For example, the sustain electrode 31 and the scan electrode 32 include the discharge gap DG, transparent electrodes 31a and 32a that form a surface discharge region, and bus electrodes 31b and 32b that apply voltage signals to the transparent electrodes 31a and 32a.

The transparent electrodes 31a and 32a are made of a transparent material (i.e., indium tin oxide (ITO)) to secure an aperture ratio of the discharge cell 17. Further, the bus electrodes 31b and 32b are disposed on the transparent electrodes 31a and 32a at a position separate (or away) from the discharge gap and made of a metallic material having high electrical conductivity so as to apply the voltage signals to the transparent electrodes 31a and 32a.

The transparent electrodes 31a and 32a may be formed of a protruding electrode that protrudes toward the discharge gap DG from each of the bus electrodes 31b and 32b to correspond to each of the discharge cells 17.

A second dielectric layer 21 covers the inner surface of the front substrate 20, the sustain electrode 31, and the scan electrode 32. The second dielectric layer 21 protects the sustain electrode 31 and the scan electrode 32 from the gas discharge by protecting (or preventing) the positive ions or electrons from colliding directly with the sustain electrode 31 and the scan electrode 32 in discharge. Further, the second dielectric layer 21 provides the forming and accumulation spaces of the wall charges to enable the sustain discharge by the low voltage.

In addition, the second dielectric layer 21 induces weak discharge by lowering density of discharge current in the discharge gap DG and at a portion adjacent to the discharge gap DG on which an electric field is concentrated to reduce energy loss, thereby improving luminous efficiency. As one example, the second dielectric layer 21 includes a first dielectric constant section 21a and a second dielectric constant section 21b that have different dielectric constants so as to reduce a capacitance in the discharge gap DG and at the portion adjacent to the discharge gap DG.

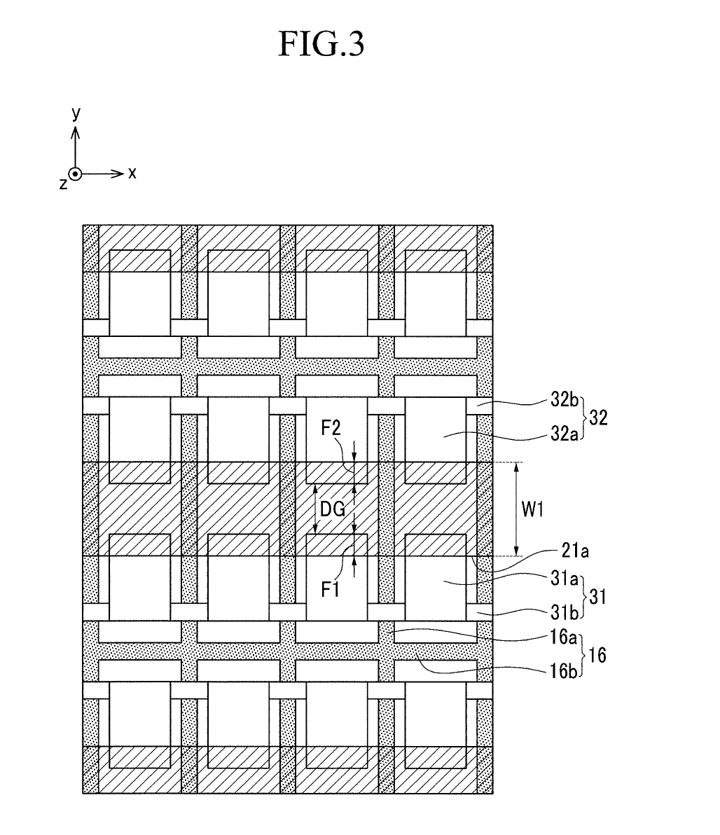

FIG. 3 is a plan schematic view of a disposition relationship of a display electrode, a first dielectric constant section, and a discharge cell. Referring to FIG. 3, the first dielectric constant section 21a, having a width W1, is formed in the discharge gap DG and at the portion adjacent to the discharge gap DG and has a first dielectric constant ε1. The second dielectric constant section 21b is formed on the inner surface of the front substrate 20 over the scan electrodes 32 and the sustain electrodes 31, and has a second dielectric constant ε2 larger than the first dielectric constant ε1 (ε1<ε2).

That is, in the discharge gap DG, end portions of the transparent electrodes 31a and 32a and the first dielectric constant section 21a have first and second regions F1 and F2 that are overlapped with each other. Therefore, the first dielectric constant section 21a induces the weak discharge by lowering the capacitance and the density of the discharge current in the discharge gap DG and the first and second regions F1 and F2.

Therefore, the first dielectric constant section 21a reduces the energy loss by lowering the capacitance and the density of the discharge current in the discharge gap DG on which the electric field is concentrated and at the portion adjacent to the discharge gap DG on which the electric field is concentrated.

As the first and second regions F1 and F2 are large, weaker discharge may be induced by lowering the capacitance and the discharge current by the first dielectric constant section 21a, but when the first and second regions F1 and F2 are too large, the weak discharge is induced even at a position away (or distant) from the discharge gap DG, such that desired luminance may not be achieved. Therefore, the first and second regions F1 and F2 are limited to a size range to lower the capacitance and the density of the discharge current without interrupting display of an image by sustain discharge.

In one example, the first dielectric constant section 21a is not sintered, and the second dielectric constant section 21b is sintered. The first dielectric constant section 21a includes insulator particles that are not sintered, and the insulator particles have a property that does not absorb visible light. In one example, the insulator particles include SiO₂ and/or Al₂O₃.

Referring back to FIG. 2, the second dielectric constant section 21b covers a top surface of each of the sustain electrode 31 and the scan electrode 32 and the inner surface of the front substrate 20 that is not covered with the sustain electrode 31 and the scan electrode 32. The first dielectric constant section 21a is formed on the surface of the second dielectric constant section 21b that corresponds to the discharge gap DG and the portion adjacent to the discharge gap DG. Therefore, the first dielectric constant section 21a may protrude toward the inner surface of the rear substrate 10 further than the second dielectric constant section 21b.

The protective layer 23 covers the second dielectric layer 21, and more particularly, covers the first dielectric constant section 21a and the second dielectric constant section 21b where the first dielectric constant section 21a is not formed. For example, the protective layer 23 is made of transparent MgO that protects the first dielectric constant section 21a and the second dielectric constant section 21b in gas discharge and increases secondary electron emission coefficient in discharge.

In addition, the first and second dielectric constant sections 21a and 21b will be described in more detail. A thickness T1 of the first dielectric constant section 21a that is not sintered is about 1/10 of a thickness T2 of the second dielectric constant section 21b that is sintered (T1=T2/10). For example, the thickness T1 of the first dielectric constant section 21a is about 2 μm. When the protective layer 23 is formed on the first dielectric constant section 21a, a gap of about 2 μm is formed between the protective layer 23 and the first barrier rib 16a, but crosstalk does not occur.

Since the first dielectric constant section 21a is not sintered, the first dielectric constant section 21a has a space that is formed between dielectric particles and has a very low first dielectric constant ε1. In the case of the dielectric particles completed from a compound containing SiO₂ having a low dielectric constant, the first dielectric constant ε1 of the first dielectric constant section 21a may decrease to about 1.

The sintered second dielectric constant section 21b has a second dielectric constant a of between 7 and 20. Therefore, the capacitance formed in the discharge gap DG and the capacitance formed between the sustain electrode 31 or the scan electrode 32 and the protective layer 23 at the portion (that is, first and second regions F1 and F2) adjacent to the discharge gap DG may decrease.

As the capacitance decreases, the density of the discharge current in the discharge gap DG and at the portion adjacent to the discharge gap DG is lowered, and the weak discharge is induced, such that the energy loss in the discharge gap DG and at the portion adjacent to the discharge gap DG on which the electric field is concentrated is reduced in discharge. That is, the luminous efficiency is improved.

For example, when the second dielectric constant ε2 is 13, the thickness T2 is 20 μm in the second dielectric constant section 21b, the first dielectric constant ε1 is 1.3 and the thickness T2 is 2 μm in the first dielectric constant section 21a, the capacitance C in the discharge gap DG and at the portion adjacent to the discharge gap DG where the first dielectric constant section 21a is provided is reduced by half.

$$C = ɛ \frac{A}{d} \qquad Equation 1$$

In Equation 1, ε represents dielectric constant ε1 or ε2 of a dielectric, A represents an area of the dielectric, and d represents thickness T1 or T2 of the dielectric.

That is, referring to Equation 1, since the area A is constant, the capacitance C is calculated as (1/(T2/ε2+T1/ε1))/(ε2/T2)=(1/(20/13+2/1.3))/(13/20)=0.5.

In addition, since the portion distant from (i.e., the portion of the second dielectric layer 21 that is away from) the discharge gap DG includes only the second dielectric constant section 21b without the unsintered first dielectric constant portion 21a, the capacitance at the portion distant from the discharge gap DG is equal to the capacitance in related art.

Further, even though the unsintered first dielectric constant section 21a is inserted into the discharge gap DG and the portion adjacent to (i.e., the portion of the second dielectric layer 21 that is adjacent to) the discharge gap DG, sustain voltage applied to the sustain electrode 31 and the scan electrode 32, which should be utilized for sustain discharge does not substantially increase.

Here, unsintered insulator particles are collected to form the first dielectric constant section 21a. A paste is prepared by mixing the insulator particles with an organic dispersion material, the paste is applied onto the surface of the sintered second dielectric constant section 21b in patterns by a screen printing method and/or a dispenser method, and an organic component is removed by heat-treating the pattern to form the first dielectric constant section 21a.

The heat-treatment of the paste pattern for forming the first dielectric constant section 21a is performed at a temperature at which the insulator particles maintain an unsintered state. For example, the insulator particles that are made of a high-melting-point oxide, such as SiO₂ or Al₂O₃, are heat-treated at a heat-treatment temperature (i.e., 600° C. or lower) that is suitably used in a PDP manufacturing process.

When heat-treatment of the first dielectric constant section 21a and heat-treatment for sintering the second dielectric constant section 21b are performed at the same (or substantially the same) time, a separate heat-treatment of the pattern for forming the first dielectric constant section 21a need not be added.

The first dielectric constant section 21a is transparent and transmits visible light (i.e., light having a wavelength between 400 and 700 nm) generated from the phosphor layer 19 toward the front substrate 20 without interrupting the visible light. Further, the insulator particles of the first dielectric constant section 21a have an average grain size that is still smaller than the wavelength of the visible light, thereby reducing (or minimizing) dispersion of the visible light. For example, the insulator particles of the first dielectric constant section 21a may be smaller than 100 nm. When the insulator particles of the first dielectric constant section 21a are formed of a material having a low refractive index such as SiO₂, the insulator particles can effectively suppress the dispersion of the visible light.

In the first exemplary embodiment, the pattern of the first dielectric constant section 21a is plated on the second dielectric constant section 21b, but the pattern may be inserted into the second dielectric constant section 21b or inserted between the second dielectric constant section 21b and the sustain and scan electrodes 31 and 32.

Reset discharge occurs by a reset pulse applied to the scan electrode 32 during a reset period while driving the plasma display panel 100. Address discharge occurs by a scan pulse applied to the scan electrode 32 and an address pulse applied to the address electrode 11 during an addressing period subsequent to the reset period. Thereafter, the sustain discharge occurs by a sustain pulse applied to the sustain electrode 31 and the scan electrode 32 during a sustain period.

The sustain electrode 31 and the scan electrode 32 serve as an electrode that applies the sustain pulse required for the sustain discharge. The scan electrode 32 serves as an electrode that applies the reset pulse and the scan pulse, and the address electrode 11 serves as an electrode that applies the address pulse.

The sustain electrode 31, the scan electrode 32, and the address electrode 11 may play different roles depending on the waveform of voltage applied to the electrodes. Therefore, the electrodes may play different roles.

The plasma display panel 100 selects a discharge cell 17 to be turned on by the address discharge that occurs by an interaction between the address electrode 11 and the scan electrode 32 and drives the selected discharge cell 17 by the sustain discharge that occurs by an interaction between the sustain electrode 31 and the scan electrode 32 to display the image.

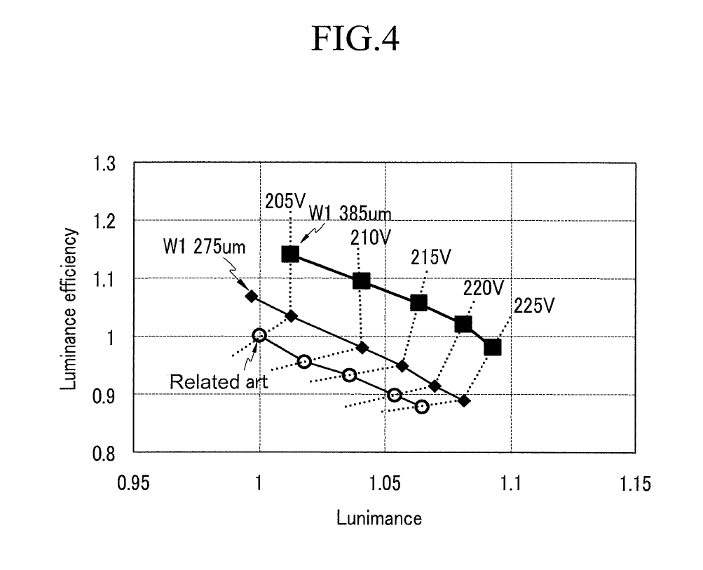

FIG. 4 is a graph illustrating a relationship between luminance and luminous efficiency depending on sustain discharge voltage and a width of a first dielectric constant section. Referring to FIG. 4, 6-inch test plasma display panels having widths

W1 of the first dielectric constant section 21a of 275 micrometers and 385 micrometers are fabricated. Herein, the second barrier rib members 16b are spaced apart from each other with a period of 675 micrometers in the y-axis direction.

The graph of FIG. 4 illustrates luminance and luminous efficiency in the related art without the first dielectric constant section 21a and luminance and luminous efficiency when the same sustain voltage is variously applied to the sustain electrode 31 and the scan electrode 32 of the plasma display panels of Experimental Examples 1 and 2, which have widths W1 of the first dielectric constant section 21a of 275 micrometers and 385 micrometers, respectively, under the same (or substantially the same) condition.

When the sustain voltage is the same (or substantially the same), the luminance and luminous efficiency of Experimental Example 1 are improved in comparison with the related art and the luminance and luminous efficiency of Experimental Example 2 is improved in comparison with Experimental Example 1, in general. Further, when the width W1 of the first dielectric constant section 21a increases as the discharge gap DG is constant, the capacitance and current decrease while the first and second regions F1 and F2 increase, such that the luminous efficiency is further improved.

In FIG. 4, in the case of points having sustain voltage of 205 V, when Experimental Examples 1 and 2 have the same luminance of about 1.02, Experimental Example 1 has luminous efficiency of 1.04 and Experimental Example 2 has luminous efficiency of 1.15. Therefore, Experimental Example 2 at the same luminance as that of Experimental Example 1 has luminous efficiency higher than that of Experimental Example 1. By contrast, the related art having the sustain voltage of 205 V has luminance of 1 and luminous efficiency of 1. That is, Experimental Examples 1 and 2 have relatively high luminance and luminous efficiency as compared to the related art.

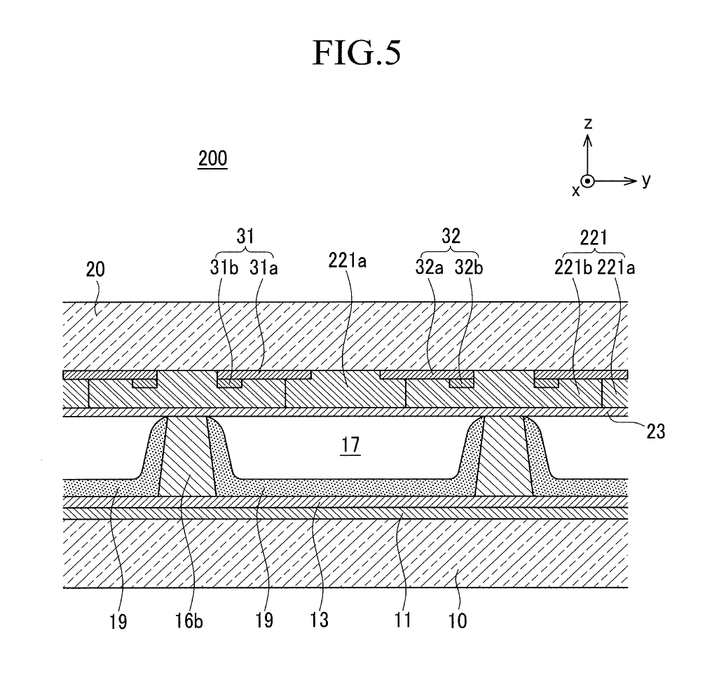

FIG. 5 is a cross-sectional schematic view of a plasma display panel according to a second exemplary embodiment of the present invention. Since the first and second exemplary embodiments include similar components, in the following description of the second exemplary embodiment, the description of the same components will not be provided again, and the description of different components will be described in comparison with the first exemplary embodiment.

Referring to FIG. 5, in the plasma display panel 200, first and second dielectric constant sections 221a and 221b are formed on the inner surface of the front substrate 20 which is generally on the same plane. That is, the first dielectric constant section 221a is formed on the inner surface of the front substrate 20 that corresponds to the discharge gap DG and the surface of each of the sustain electrode 31 and the scan electrode 32 at the portion adjacent to the discharge gap DG.

The second dielectric constant section 221b is formed at either side (or both sides) of the first dielectric constant section 221a in the y-axis direction. That is, the second dielectric constant section 221b is formed on the surface of each of the sustain electrode 31 and the scan electrode 32 and the inner surface of the front substrate 20.

The capacitance formed in the discharge gap DG and at the portion adjacent to the discharge gap DG by the first dielectric constant section 221a is smaller than the capacitance at the portion distant from the discharge gap DG. As the capacitance decreases, the density of the discharge current in the discharge gap DG and at the portion adjacent to the discharge gap DG is lowered, thus, the weak discharge is induced, such that the energy loss in the discharge gap DG and at the portion adjacent to the discharge gap DG on which the electric field is concentrated is reduced. That is, the luminous efficiency is improved.

At this time, the first and second dielectric constant sections 221a and 221b are sintered. The second dielectric constant section 221b may be formed by a suitable dispenser method (i.e., may be a dispensed constant section).

A dielectric paste having a first dielectric constant ε1 and a dielectric paste having a second dielectric constant E2 are separately provided. That is, the dielectric paste having the first dielectric constant ε1 is dispensed and applied to correspond to the discharge gap DG and the portion adjacent to the discharge gap DG, and the dielectric paste having the second dielectric constant ε2 is dispensed and applied to a space between dielectric stripe patterns of the first dielectric constant ε1 to form the first and second dielectric constant sections 221a and 221b.

Stripe patterns of the both pastes are naturally leveled in contact with each other by flowability of the dielectric pastes having the first and second dielectric constants ε1 and ε2. Here, the pastes are dispersed therebetween on a contact interface, but the pastes have viscosity, such that the pastes are not rapidly dispersed, thus, the pastes are not deeply dispersed.

When the both paste patterns are dried during the dispersion, the first and second dielectric constant sections 221a and 221b are fixed while being applied with the dielectric pastes and when the first and second dielectric constant sections 221a and 221b are heat-treated for sintering, the first and second dielectric constant sections 221a and 221b are sintered. In order to block (or prevent) the both pastes from being dispersed on the interface, the dielectric paste having the second dielectric constant ε2 is applied after the dielectric paste having the first dielectric constant ε1 is applied, and the first dielectric pattern having the first dielectric constant ε1 is dried before the second dielectric pattern having the second dielectric constant ε2.

As described above, according to an exemplary embodiment of the present invention, an electric field is concentrated on a portion adjacent to a discharge gap such that plasma density and energy loss may increase. However, in an exemplary embodiment of the present invention, comparatively weaker discharge can be induced at the portion adjacent to the discharge gap by decreasing the density of discharge current at the portion adjacent to the discharge gap and increasing the density of the discharge current at a portion distant from the discharge gap. As such, the weak discharge at the portion adjacent to the discharge gap reduces the possible energy loss, thereby improving luminous efficiency.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A plasma display panel, comprising:
a first substrate;
a second substrate facing the first substrate;
a plurality of barrier ribs partitioning a space between the first substrate and the second substrate to define a plurality of discharge cells;
a plurality of address electrodes on the first substrate and extending in a first direction to correspond to the discharge cells;
a first electrode and a second electrode extending in a second direction crossing the first direction on the second substrate to define a discharge gap at the center of a corresponding one of the discharge cells;
a dielectric layer covering the first and second electrodes; and
a protective layer covering the dielectric layer,
wherein the dielectric layer comprises,
a first dielectric constant section in the discharge gap and a portion adjacent to the discharge gap in the first direction and having a first dielectric constant, and
a second dielectric constant section at either side of the first dielectric constant section in the first direction and having a second dielectric constant larger than the first dielectric constant.

2. The plasma display panel of claim 1, wherein:
the first dielectric constant section comprises unsintered insulator particles.

3. The plasma display panel of claim 2, wherein:
the insulator particles have a property for not absorbing visible light.

4. The plasma display panel of claim 3, wherein:
the insulator particles comprise at least one of SiO₂ or Al₂O₃.

5. The plasma display panel of claim 2, wherein:
the second dielectric constant section is sintered.

6. The plasma display panel of claim 5, wherein:
the second dielectric constant section is on a surface of each of the first and second electrodes facing the first substrate, and on a surface of the second substrate facing the first substrate and not covered with the first and second electrodes.

7. The plasma display panel of claim 6, wherein:
the first dielectric constant section is on a surface of the second dielectric constant section facing the first substrate.

8. The plasma display panel of claim 1, wherein:
the first dielectric constant section is sintered.

9. The plasma display panel of claim 8, wherein:
the second dielectric constant section is sintered.

10. The plasma display panel of claim 9, wherein:
the second dielectric constant section is a dispensed dielectric constant section.

11. The plasma display panel of claim 9, wherein:
the first dielectric constant section covers a surface of the second substrate facing the first substrate to correspond to the discharge gap, and covers a surface of each of the first and second electrodes facing the first substrate at a portion adjacent to the discharge gap in the first direction.

12. The plasma display panel of claim 11, wherein:
the second dielectric constant section covers a surface of each of the first and second electrodes facing the first substrate, and covers a surface of the second substrate facing the first substrate at either side of the first dielectric constant section in the first direction.

13. The plasma display panel of claim 1, wherein:
the second dielectric constant section is on a surface of each of the first and second electrodes facing the first substrate, and on a surface of the second substrate facing the first substrate and not covered with the first and second electrodes.

14. The plasma display panel of claim 13, wherein:
the first dielectric constant section is on a surface of the second dielectric constant section facing the first substrate.

15. The plasma display panel of claim 1, wherein:
the first dielectric constant section covers a surface of the second substrate facing the first substrate to correspond to the discharge gap, and covers a surface of each of the first and second electrodes facing the first substrate at a portion adjacent to the discharge gap in the first direction.

16. The plasma display panel of claim 15, wherein:
the second dielectric constant section covers a surface of each of the first and second electrodes facing the first substrate, and covers a surface of the second substrate facing the first substrate at either side of the first dielectric constant section in the first direction.
